(19) United States
(12) Patent Application Publication
(10) Pub. No.: US 2023/0183398 A1
(43) Pub. Date: Jun. 15, 2023

(54) PRESSURE-SENSITIVE ADHESIVE FOR BONDING PRINTING PLATES

(71) Applicant: tesa SE, Norderstedt (DE)

(72) Inventors: Bianca MAYER, Hamburg (DE); Benjamin PUETZ, Neuss (DE); Ralf KRETZMER, Hamburg (DE); Alexander ENGEL, Hamburg (DE)

(73) Assignee: tesa SE, Norderstedt (DE)

(21) Appl. No.: 18/085,574

(22) Filed: Dec. 21, 2022

(30) Foreign Application Priority Data
Dec. 12, 2021 (DE) 10 2021 133 983.9

(51) Int. Cl. C08F 120/06; C09J 133/08; B32B 37/12

(52) U.S. Cl. CPC C08F 120/06; C09J 133/08; B32B 37/12; C09J 2301/302

(57) ABSTRACT

A pressure-sensitive adhesive for bonding printing plates comprises one or more poly(meth)acrylates in a combined mass fraction of 50% or more and preparable by polymerization of a monomer composition comprising, based on the mass of the monomer composition: i) one or more first monomers selected from acrylic acid, methacrylic acid, dimethylacrylamide, hydroxybutyl acrylate, hydroxypropyl acrylate and hydroxyethyl acrylate in a combined mass fraction in the range from 10%-20%, and ii) one or more second monomers selected from (meth)acrylic esters of the formula (I), CH₂═CR¹—C(O)O—CHR²R³ (I), where R¹ is hydrogen or methyl, where either i) R² is hydrogen and R³ is a branched alkyl group having 16-20 carbon atoms, or ii) R² is a linear or branched alkyl group having 3-10 carbon atoms and R³ a linear or branched alkyl group having 6-10 carbon atoms, in a combined mass fraction in the range from 20%-90%.

This application claims priority of German Patent Application No. 10 2021 133 983.9, filed Dec. 21, 2021, the entire contents of which patent application is hereby incorporated herein by reference.

The invention relates to a pressure-sensitive adhesive for bonding printing plates, to a corresponding pressure-sensitive adhesive tape, and to the use of such pressure-sensitive adhesives and adhesive tapes for improving the detachability of adhered printing plates in the context of the processing of ink containing cellulose nitrate.

The joining of separate elements is one of the central processes in manufacturing. As well as other methods, such as welding and soldering, for example, an important significance is nowadays accorded in particular to adhesive bonding, i.e. to joining using an adhesive. One alternative to the use of formless adhesives which are applied from a tube, for example, are so-called adhesive tapes, whose bonding effect derives from the adhesives employed.

For numerous technical applications, pressure-sensitive adhesive tapes in particular are relevant, where a pressure-sensitive adhesive (PSA) provides the bonding effect, being durably tacky and also adhesive under customary ambient conditions. Such pressure-sensitive adhesive tapes can be applied to a substrate by pressure and remain adhering there, but later on can be removed again more or less without residue.

There are numerous technical fields in which pressure-sensitive adhesive tapes enjoy great popularity, since generally they are particularly easy to use and enable the rapid and uncomplicated joining of multiple elements. As well as fields of use in industries whose products are part of everyday life for the majority of people, as in the manufacture of vehicles and electronic devices, for example, pressure-sensitive adhesive tapes are also employed in areas which are less apparent on an everyday basis. Here it is frequently these very applications—usually highly specialized—that impose particular requirements on the physicochemical properties of PSAs.

One important branch of industry which is particularly reliant on performance-capable pressure-sensitive adhesive tapes is the printing industry. In the printing industry there are various known processes for transferring designs to substrates, with that known as flexographic printing having particularly great significance. In the flexographic printing process, flexible printing plates are affixed to printing cylinders or printing sleeves. These flexible plates frequently consist of a polyethylene terephthalate film (PET film) bearing an applied layer of a photopolymer in which the corresponding print relief can be established by selective exposure to light. In the flexographic printing process, pressure-sensitive adhesive tapes, usually in the form of double-sided adhesive tapes, are used in particular for securing the printing plates, used for printing substrates, on the printing cylinders or printing sleeves of the apparatuses used. The requirements of the printing industry are that during the printing operation it is possible to ensure sufficient assembly strength of the adhered printing plates, even at elevated temperatures of about 40 to 60° C. At the same time, however, after printing, the corresponding printing plates must be able to be removed extremely easily and time-efficiently from the apparatuses, possibly even after prolonged bonding of 6 months, for example, where the removal must be possible as far as possible without residue and without damaging the printing plates. This operation of removing the printing plates, which in practice is frequently performed manually by operatives, requires the pressure-sensitive adhesive tapes used to ensure ready detachability of the printing plates after the printing operation, so that the operatives deployed are not required to apply excessive force in order to change a printing plate. Further information is disclosed for example in DE 10 2016 213 185 A1 or EP 3 239 260 A1.

One particular feature of this application is that many of the inks used in the printing industry comprise a multiplicity of chemical substances, which may influence the adhesive properties of the pressure-sensitive adhesive tapes used. In particular, many inks comprise cellulose nitrate (sometimes also referred to colloquially as nitrocellulose), which acts as a binder in these inks.

Even in the case of a very rigorous process regime, the reverse sides of the printing plates for bonding, and/or the surfaces of the printing cylinders of corresponding printing apparatuses, are frequently contaminated with such substances as cellulose nitrate. These contaminants are frequently not caused only by splashes of ink or by other instances of direct ink contact, but instead in many cases are also a consequence of the process used for cleaning the printing plates. It is usually the case, indeed, that the printing plates, after being used, are passed through a cleaning bath, which by the time of the second cleaning at the latest comprises cellulose nitrate. This cleaning bath usually wets the printing plates completely, and so residues of cellulose nitrate remain on all sides of the printing plates.

The presence of cellulose nitrate on the printing plate faces intended for bonding is generally perceived as disadvantageous. The reason is that cellulose nitrate can act as an adhesion promoter between the printing plate and the pressure-sensitive adhesive used, causing a significant increase in the peel adhesion of the PSAs. In practice this means that printing plates bonded with conventional PSAs, after being used, frequently exhibit inadequate detachability from the printing cylinders. As a result, for the operatives deployed, the removal of the printing plates becomes significantly more effortful, as they are required to apply high forces in order to part the printing plates. Furthermore, there may also be disadvantageous effects on the time and cost efficiency of the overall printing operation, if, for example, the apparatuses used must be kept at standstill longer for the purpose of removing the printing plates; if there are instances of damage to the printing plates during detachment, owing to the strong adhesion; and/or if pressure-sensitive adhesive tapes for replacement cannot be parted from the printing cylinders without great effort, as a result, for example, of a cohesive failure promoted by the increased adhesion.

In the field of pressure-sensitive adhesives, poly(meth)acrylates in particular have proven in principle to be very effectively employable base materials. These polymeric compounds generally possess physicochemical properties which predestine them for use in PSAs—for example, a high light stability, resistance to effects of weathering and to a multiplicity of chemicals, and also a high intrinsic peel adhesion and an advantageous ageing resistance. Poly(meth)acrylate-based adhesives, furthermore, can generally be employed across a broad range of substrates, in particular on both polar and less polar substrates, such as on glass and steel, for example, but also on plastics, such as polystyrene or polycarbonates, for example. In the technical field of adhesive technology, accordingly, there is continued interest in enhancing the physicochemical properties of poly(meth)acrylate-based PSAs, particularly their technical adhesive properties.

Against this background, poly(meth)acrylate-based PSAs are in principle a PSA highly promising for use in the printing industry as well. In spite of the fundamental advantages of such poly(meth)acrylate-based PSAs, however, the above-described problem of the interaction with cellulose nitrate is frequently perceived as a particular disadvantage with these systems, so reducing their usefulness.

The primary object of the present invention was to eliminate or at least reduce the above-described disadvantages of the prior art.

A particular object of the present invention was to specify a pressure-sensitive adhesive which has sufficient pressure-sensitive adhesiveness in order securely to affix the printing plates used in the printing industry to typical substrates, particularly steel and plastics, during use, yet at the same time enabling ready detachability of the printing plates and, correspondingly, an extremely easy dissolubility of the adhesively bonded assembly. In this context, the ease of demounting of printing plates affixed with such PSAs ought to be possible in particular even when the PSAs come into contact with chemical substances, particularly cellulose nitrate, in their use.

It was desirable, accordingly, that the PSAs to be specified should be preparable as far as possible using starting materials and processes which are already employed in the field of adhesive technology, in order to enable time-efficient and cost-efficient production.

A supplementary object of the present invention was to specify an advantageous pressure-sensitive adhesive tape.

The inventors have now found that the objects described above can surprisingly be achieved by using, in a pressure-sensitive adhesive, specific poly(meth)acrylates which are constituted of monomer units in a specifically determined way as defined in the claims. It was particularly surprising, accordingly, that the objects above are achievable only when using particular branched (meth)acrylate monomers in combination with a comparatively high proportion of particular functional monomers, as is disclosed below.

Without wishing to be tied to this theory, the inventors assume that it is possible in this way to obtain poly(meth)acrylates whose dynamic Tg, i.e. whose dynamic glass transition temperature, exhibits a particularly heavy dependency on the frequency, or speed, so that during detachment of the printing plates, even at low speeds, they come particularly quickly into a state of “juddering”, thereby promoting the demounting of the printing plates and the dissolution of the adhesively bonded assembly.

The objects stated above are therefore achieved by the subject matter of the invention as defined in the claims. Preferred configurations of the invention are evident from the dependent claims and from the observations hereinafter.

Those embodiments designated hereinafter as preferred are combined, in particularly preferred embodiments, with features of other embodiments designated as preferred. Especially preferred, accordingly, are combinations of two or more of the embodiments designated hereinafter as particularly preferred. Likewise preferred are embodiments in which a feature of an embodiment that is designated as preferred to any extent is combined with one or more further features of other embodiments which are designated as preferred to any extent. Features of preferred pressure-sensitive adhesive tapes and uses are a product of the features of preferred pressure-sensitive adhesives.

Where, hereinafter, for an element, for example for the poly(meth)acrylates or a particular monomer, both specific amounts or fractions of that element and preferred configurations of the element are disclosed, there is also disclosure in particular of the specific amounts or fractions of the elements with preferred configuration. There is also disclosure to the effect that, for the corresponding specific total amounts or total fractions of the elements, at least a part of the elements may have preferred configuration, and also, in particular, there is disclosure to the effect that elements with preferred configuration within the specific total amounts or total fractions may be present in turn in the specific amounts or fractions, respectively.

The invention relates to a pressure-sensitive adhesive for the bonding of printing plates, comprising one or more poly(meth)acrylates in a combined mass fraction of 50% or more, based on the mass of the pressure-sensitive adhesive, wherein the one or the two or more poly(meth)acrylates are preparable by polymerization of a monomer composition comprising, based on the mass of the monomer composition:
i) one or more first monomers selected from the group consisting of acrylic acid, methacrylic acid, dimethylacrylamide, hydroxybutyl acrylate, hydroxypropyl acrylate and hydroxyethyl acrylate in a combined mass fraction in the range from 10% to 20%, and
ii) one or more second monomers selected from the group consisting of (meth)acrylic esters of the formula (I),

CH₂═CR¹—C(O)O—CHR²R³ (I),
where R¹ is a hydrogen atom or a methyl group, where either i) R² is a hydrogen atom and R³ is a branched alkyl group having 16 to 20 carbon atoms, or ii) R² is a linear or branched alkyl group having 3 to 10 carbon atoms and R³ a linear or branched alkyl group having 6 to 10 carbon atoms, in a combined mass fraction in the range from 20% to 90%.

The pressure-sensitive adhesives of the invention are intended for use in the printing industry and are suitable accordingly for the bonding of printing plates.

A pressure-sensitive adhesive (PSA), in agreement with the understanding of the skilled person, is an adhesive which possesses pressure-sensitive adhesive properties, i.e. has the capacity to enter into a durable bond with respect to a substrate even under relatively weak applied pressure. Corresponding pressure-sensitive adhesive tapes are typically redetachable from the substrate substantially without residue after use, and in general have a permanent intrinsic tack even at room temperature, meaning that they have a certain viscosity and touch-tackiness, so that they wet the surface of a substrate even under low applied pressure. The pressure-sensitive adhesiveness of a pressure-sensitive adhesive tape is a product of the use as adhesive of a pressure-sensitive adhesive. Without wishing to be tied to this theory, it is frequently assumed that a pressure-sensitive adhesive may be considered to be a fluid of extremely high viscosity with an elastic component, accordingly having characteristic viscoelastic properties which lead to the above-described durable intrinsic tackiness and pressure-sensitive adhesive capability. It is assumed that with such PSAs, on mechanical deformation, there are viscous flow processes and there is development of elastic forces of resilience. The viscous flow component serves to achieve adhesion, while the elastic forces of resilience component is needed in particular for the achievement of cohesion. The relationships between the rheology and the pressure-sensitive adhesiveness are known in the prior art and described for example in Satas, “Handbook of Pressure Sensitive Adhesives Technology”, Third Edition (1999), pages 153 to 203. To characterize the extent of the elastic and viscous components, it is usual to employ the storage modulus (G′) and the loss modulus (G″), which may be ascertained by dynamic mechanical analysis (DMA), using a rheometer, for example, as disclosed for example in WO 2015/189323. For the purposes of the present invention, an adhesive is understood preferably to have pressure-sensitive adhesiveness and hence to be a pressure-sensitive adhesive when at a temperature of 23° C. in the deformation frequency range from 10° to 10¹ rad/sec, G′ and G″ are each situated at least partly within the range from 10³ to 10⁷ Pa.

The PSA of the invention comprises poly(meth)acrylates, which in turn are preparable or prepared from various monomers. These constituents, in agreement with the understanding of the skilled person, are used in each case as “one or more”. This designation “one or more” refers, in the manner customary in the sector, to the chemical nature of the compounds in question and not to their amount of substance. For example, the monomer composition may as its first monomer comprise exclusively acrylic acid, meaning that the monomer composition comprises a multiplicity of acrylic acid molecules.

In the context of the present invention, the expression “poly(meth)acrylates”, in agreement with the understanding of the skilled person, embraces polyacrylates and polymethacrylates and also copolymers of these polymers. Poly(meth)acrylates may contain relatively small amounts of monomer units not deriving from (meth)acrylates. A “poly(meth)acrylate” in the context of the present invention, accordingly, is a (co)polymer whose monomer basis consists to a mass fraction of 70% or more, preferably 90% or more, particularly preferably 98% or more, of monomers selected from the group consisting of acrylic acid, methacrylic acid, acrylic esters and methacrylic esters, based on the mass of the monomer basis. The mass fraction of acrylic ester and/or methacrylic ester is preferably 50% or more, particularly preferably 70% or more. Poly(meth)acrylates are accessible generally through radical polymerization of acrylic- and/or methacrylic-based monomers and also, optionally, further copolymerizable monomers.

In agreement with the understanding of a skilled person and with the customary approach in the field of art, it is useful to define polymeric compounds such as the poly(meth)acrylates by way of the preparation process and/or by way of the starting materials used in the preparation, since it is impossible to give a sensible definition of the materials in question otherwise.

The preparation of the poly(meth)acrylates from the monomer composition may take place according to the commonplace processes, especially by conventional radical polymerizations or controlled radical polymerizations. The polymers and/or oligomers may be prepared by copolymerizing the monomeric components using the customary polymerization initiators and also, optionally, chain transfer agents; polymerization may take place at the customary temperatures for example in bulk, in emulsion, such as in water or liquid hydrocarbons, for example, or in solution. The poly(meth)acrylates and/or the tackifying resins are prepared preferably by polymerization in solvents, particularly preferably in solvents having a boiling temperature in the range from 50 to 150° C., particularly preferably in the range from 60 to 120° C., using the customary amounts of polymerization initiators; the polymerization initiators are added to the monomer composition generally in a fraction of about 0.01% to 5%, more particularly of 0.1% to 2%, based on the mass of the monomer composition.

Suitable polymerization initiators are, for example, radical sources such as peroxides, hydroperoxides and azo compounds, e.g. dibenzoyl peroxide, cumene hydroperoxide, cyclohexanone peroxide, di-tert-butyl peroxide, cyclohexylsulfonyl acetyl peroxide, diisopropyl percarbonate, tert-butyl peroctoate or benzopinacol. A particularly preferred radical initiator used is 2,2′-azobis(2-methylbutyronitrile) or 2,2′-azobis(2-methylpropionitrile). Solvents suitable include, in particular, alcohols such as methanol, ethanol, n-propanol and isopropanol, n-butanol and isobutanol, preferably isopropanol and/or isobutanol, and also hydrocarbons such as toluene and, in particular, benzines having a boiling temperature in the range from 60 to 120° C. In particular it is possible to use ketones, such as acetone, methyl ethyl ketone and methyl isobutyl ketone, for example, and esters, such as ethyl acetate, for example, and also mixtures of these solvents.

The poly(meth)acrylates for use in the invention are preparable or prepared by polymerization of a specific monomer composition which comprises particular monomers having specific functional groups, i.e. the first monomers, and particular branched monomers, i.e. the second monomers, and preferably also a maximum amount of particular borneol derivatives.

Accordingly it was initially particularly surprising to the inventors that the achievement of the objects above is dependent sensitively on the first monomers and their mass fraction—indeed, they can only be used in a relatively narrow mass fraction range.

These first monomers are also relevant in particular for any subsequent crosslinking of the poly(meth)acrylates, which is in many cases preferred as described hereinafter. In this context, the carboxylic acid-containing monomers and/or the hydroxyalkyl acrylates used, and also the dimethylacrylamide, in each case usually utilize a different crosslinking chemistry, as elucidated further hereinafter. It is particularly preferred in this context if the first monomers used comprise predominantly, with particular preference substantially completely, either the above-stated carboxylic acids or the above-stated hydroxyalkyl acrylates, with the fraction of the majority component used being greater preferably by a factor of 50 or more, preferably 100 or more, than the mass fraction of the other component.

According to the insight of the inventors, dimethylacrylamide has a particular significance among the first monomers in that it can be mixed particularly readily with the carboxylic acids or the hydroxyalkyl acrylates and has excellent suitability for establishing the required combined mass fraction of the first monomers. With a view to advantageous processing, especially to efficient crosslinking of the poly(meth)acrylates prepared, however, it is preferred if the monomer composition as well as dimethylacrylamide comprises at least one further first monomer, preferably in a mass fraction of 0.1% or more, particularly preferably of 1% or more, based on the mass of the monomer composition, in order to enable a greater flexibility in the crosslinking of the poly(meth)acrylates.

In the estimation of the inventors, the branched second monomers are particularly relevant for the high tolerance of the resultant PSAs of the invention to the influence of cellulose nitrate. Based on the comprehensive experiments by the inventors, it has been possible accordingly to undertake a reliable description of the structure of those branched monomers which result in corresponding advantageous poly(meth)acrylates. As described above, the second monomers may be described in principle by the following constitutional formula:

CH₂═CR¹—C(O)O—CHR²R³.

The radical R¹ here initially defines only whether the second monomer in question is an acrylate or methacrylate, with acrylates being particularly preferred. On this basis, as described above, there are two different alternatives for suitable second monomers. If R², i.e. one of the radicals in that part of the second monomers that is attached via the ester bond, is a hydrogen atom, the other radical, R³, must be a branched alkyl group having at least 16 carbon atoms, so that the part of the second monomers that is attached by the ester bond comprises in total at least 17 carbon atoms. Alternatively, if R² itself is a linear or branched alkyl group having at least 3 carbon atoms, R³ may be a linear or branched alkyl group having 6 to 10 carbon atoms. Through the use of these branched monomers having relatively long chain lengths it is possible, in combination with the first monomers, surprisingly, to obtain poly(meth)acrylate-based PSAs which exhibit high resistance to cellulose nitrate and which when used for the securement of printing plates ensure not only the adhesive strength that is required in operation but subsequently enable sufficient detachability of the printing plates even after lengthy operation.

Aside from the first and second monomers to be used in the invention, the experiments by the inventors have shown that the poly(meth)acrylates for use in the invention are very flexible in terms of the further monomers in the monomer composition for the great majority, or for virtually all, of the possible further monomers. Notable and very surprising, however, is that there is a marked exception from this finding. Surprisingly, and unexplainable to the inventors, the addition of (meth)acrylic esters of borneol and/or isoborneol, such as isobornyl acrylate, for example, impairs the resistance of the PSAs of the invention to the effect of cellulose nitrate, at least if these monomers are present in too high a mass fraction, with the threshold, on the basis of the experiments by the inventors, being situated at a mass fraction of 10%. In one embodiment, therefore, the monomer composition for preparation of the one or more poly(meth)acrylates comprises
iii) a combined mass fraction of at most 10% of third monomers selected from the group consisting of (meth)acrylic esters of borneol or isoborneol.

Without wishing to be tied to this theory, the inventors assume that it is the very specific structure of the borneol or isoborneol, which opens up an unexpected interaction with the cellulose nitrate, which leads to an unexpectedly high increase in the peel adhesion when PSAs of the invention are used in the printing industry, with the possibly resultant highly disadvantageous influence on the detachability of the printing plates. From the fact that, in accordance with the experiments carried out, at least relatively small mass fractions of such monomers have little or no adverse effect on the advantageous properties of PSAs of the invention, the inventors conclude that the adverse effect of the presence of these third monomers is in equilibrium with the fundamental advantages of PSAs of the invention, and so the latter advantages are able to dominate over the adverse influence of the third monomers up to a certain mass fraction.

In the estimation of the inventors, the advantages of PSAs of the invention are apparent as soon as they consist in large part, or predominantly, of the above-defined poly(meth)acrylates, as is defined above. In this context it may be seen as an advantage that the physicochemical properties of such PSAs of the invention may be tailored to the particular requirements by means of further constituents, such as by tackifying resins and other additives, for example, without having too adverse an effect on the resistance towards cellulose nitrate. With a view to a maximum resistance to the influence of cellulose nitrate, however, preference is given to a PSA of the invention wherein the combined mass fraction of the one or of the two or more poly(meth)acrylates is 60% or more, preferably 70% or more, particularly preferably 80% or more, very preferably 90% or more, based on the mass of the PSA.

The inventors have recognized that for optimum usefulness in the printing industry and for a particularly advantageous resolution of the conflict in objectives between sufficient pressure-sensitive adhesiveness in use and a sufficiently good detachability when the printing plates are changed, the molecular weights established in the poly(meth)acrylate ought to be comparatively high. Preference is given here to a PSA of the invention wherein the one or the two or more poly(meth)acrylates have a weight-average molecular weight Mw of 300 000 g/mol or more, preferably of 400 000 g/mol or more, particularly preferably of 500 000 g/mol or more, very preferably of 750 000 g/mol or more.

The weight-average molecular weight here is determined by gel permeation chromatography (GPC) on 100 mL of clear-filtered sample (sample concentration 0.5 g/L). The eluent used is tetrahydrofuran with 0.1% by volume of trifluoroacetic acid. The measurement is made at 25° C. The pre-column used is a PSS-SDV, 10 μm, ID 8.0 mm×50 mm column. Separation takes place using PSS-SDV, 5 μm, 10³ Å (SN9090201) and also 5 μm, 10² Å (SN9090200) columns each with ID 8.0 mm×300 mm (detection using PSS-SECurity 1260 RID differential refractometer). The flow rate is 0.5 mL per minute. Calibration takes place against PMMA standards (polymethyl methacrylate calibration).

Accordingly it is particularly useful in the estimation of the inventors to crosslink the poly(meth)acrylates using customary crosslinkers and methods that are known per se. In this context it is advantageous if the selection of the crosslinkers is custom-tailored to the poly(meth)acrylates for use in the invention and/or in particular to the first monomers. Preferred correspondingly is a PSA of the invention wherein the one or the two or more poly(meth)acrylates are preparable by a polymerization which additionally comprises a crosslinking, preferably with a chemical crosslinker and/or a physical crosslinker, the chemical crosslinker being preferably selected from the group consisting of isocyanates and epoxides, and particularly preferably is used in a mass fraction in the range from 0.05% to 2.5%, very preferably in the range from 0.1% to 0.2%, and the physical crosslinker being selected particularly preferably from the group consisting of aluminium acetylacetonate and iron acetylacetonate, and used particularly preferably in a mass fraction in the range from 0.1% to 2%, very preferably in the range from 0.3% to 1.0%.

Hydroxy-functional first monomers are crosslinked preferably by way of isocyanates, especially diisocyanates, for example poly(hexamethylene diisocyanate). First monomers with carboxylic acid functionalities are crosslinked preferably by way of epoxide compounds, for example 3,4-epoxycyclohexylmethyl 3,4-epoxycyclohexanecarboxylate or N,N,N′,N′-tetrakis(2,3-epoxypropyl)-m-xylene-α,α′-diamine.

For the inventors it was particularly surprising that the objects described above are achievable with poly(meth)acrylates which in terms of the monomer composition, particularly the amount of first and third monomers, are situated within such a narrow compositional corridor. Accordingly, however, the inventors have succeeded in deriving, from the experiments, particularly advantageous ranges with which it is possible to realize ready detachability reliably even in cases of severe contamination with cellulose nitrate. Preferred accordingly is a PSA of the invention wherein the monomer composition, based on the mass of the monomer composition:

i1) comprises the one or the two or more first monomers in a combined mass fraction in the range from 10% to 15%, preferably in the range from 10% to 13%, and/or
ii1) comprises the one or the two or more second monomers in a combined mass fraction in the range from 40% to 90%, preferably in the range from 60% to 90%, and/or
iii1) comprises a combined mass fraction of at most 8%, preferably at most 5%, more preferably at most 2%, very preferably at most 1%, of the third monomers, the monomer composition being preferably substantially free from third monomers. The skilled person understands accordingly that preferably for two or more, more preferably all, of the monomers, the ranges or preferred ranges indicated above may be set in order to obtain particularly performance-capable PSAs of the invention.

The inventors have succeeded, furthermore, in identifying particularly suitable compounds for the first and second monomers. As illustrated above, it is especially preferred for the first monomers to consist at least predominantly of the corresponding carboxylic acids or the hydroxyalkyl acrylates, in each case optionally in combination with dimethylacrylamide. Preference is therefore given to a PSA of the invention wherein, in the monomer composition:

i2) the one or the two or more first monomers are selected from the group consisting of acrylic acid, methacrylic acid and dimethylacrylamide, preferably acrylic acid and methacrylic acid, more preferably acrylic acid, or the one or the two or more first monomers are selected from the group consisting of dimethylacrylamide, hydroxybutyl acrylate, hydroxypropyl acrylate and hydroxyethyl acrylate, preferably hydroxybutyl acrylate, hydroxypropyl acrylate and hydroxyethyl acrylate. Also preferred is a PSA of the invention wherein the combined mass fraction of acrylic acid and methacrylic acid or the combined mass fraction of hydroxybutyl acrylate, hydroxypropyl acrylate and hydroxyethyl acrylate, preferably the combined mass fraction of acrylic acid and methacrylic acid, based on the combined mass of the first monomers, is 80% or more, preferably 90% or more, more preferably 98% or more.

With regard to the second monomers, acrylic esters are inherently preferred in the estimation of the inventors, with the inventors having been able to identify second monomers which are especially suitable for achieving the above-described objects and which, moreover, possess excellent processing properties, these monomers additionally contributing to excellent adhesion properties in the poly(meth)acrylates for use in the invention. Preferred accordingly is a PSA of the invention wherein, in the monomer composition:

ii2) the one or the two or more second monomers are selected from the group consisting of (meth)acrylic esters, preferably acrylic esters, of the formula (I),

CH₂═CR¹—C(O)O—CHR²R³ (I),

where R¹ is a hydrogen atom or a methyl group, preferably a hydrogen atom, where either i) R² is a hydrogen atom and R³ is a branched alkyl group having 16 to 19 carbon atoms, preferably having 16 to 18 carbon atoms, or ii) R² is a linear or branched, preferably linear, alkyl group having 3 to 8 carbon atoms, preferably having 3 to 5 carbon atoms, and R³ a linear or branched, preferably linear, alkyl group having 4 to 9 carbon atoms, preferably having 5 to 8 carbon atoms. Particular preference is given, moreover, to a PSA of the invention wherein, in the monomer composition:
ii3) the one or the two or more second monomers are selected from the group consisting of isoheptadecyl (meth)acrylate and propylheptyl (meth)acrylate, preferably isoheptadecyl acrylate and propylheptyl acrylate.

It has proven to be a particularly advantageous configuration for the use of second monomers, in the estimation of the inventors, if in each case at least one representative of the two above-defined alternatives is used, for example isoheptadecyl acrylate in combination with propylheptyl acrylate. With such mixtures of second monomers it is possible, in PSAs of the invention, to set the physicochemical properties within a particularly broad range, without adversely affecting the high resistance to cellulose nitrate. Preferred accordingly is a PSA of the invention wherein the monomer composition comprises one or more second monomers in which R² is a hydrogen atom and R³ is a branched alkyl group having 16 to 20 carbon atoms, preferably in a combined mass fraction in the range from 20% to 70%, more preferably in the range from 25% to 65%, and comprises one or more second monomers in which R² is a linear or branched alkyl group having 3 to 10 carbon atoms and R³ a linear or branched alkyl group having 6 to 10 carbon atoms, preferably in a combined mass fraction in the range from 20% to 70%, more preferably in the range from 25% to 65%.

Although, in the estimation of the inventors, the mass fractions indicated above for the first and second monomers are sufficient to achieve a markedly improved resistance to the effect of cellulose nitrate and in corresponding poly(meth)acrylates it is therefore also possible to provide further monomers which serve to establish the physicochemical properties, it is advantageous in the estimation of the inventors, for maximizing the resistance to the influence of cellulose nitrate, if the monomer composition consists predominantly or largely of the first and second monomers; in the light of the above disclosure, the absence of methacrylic esters of borneol or isoborneol is especially preferable. Preferred, consequently, is a PSA of the invention wherein the monomer composition, based on the mass of the monomer composition, comprises first monomers and second monomers in a combined mass fraction of 50% or more, preferably 60% or more, more preferably 70% or more, very preferably 80% or more, especially preferably 90% or more.

In the estimation of the inventors, the poly(meth)acrylates, aside from the third monomers as elucidated above, are relatively flexible in terms of the further monomers. Accordingly, however, the inventors have succeeded in identifying a specific class of monomers which appear to be especially compatible with the first and second monomers, since their presence does not adversely affect the high resistance of the PSAs towards cellulose nitrate, even in relatively large mass fractions. Since the corresponding monomers at the same time have advantageous processing properties and the resultant physicochemical properties of the poly(meth)acrylates can be specifically tailored to the respective fields of application through the use of these corresponding monomers, it is preferred to use these so-called fourth monomers as further constituents. Preferred accordingly is a PSA of the invention wherein the monomer composition comprises:
iv) one or more fourth monomers selected from the group consisting of (meth)acrylic esters, preferably acrylic esters, of the formula (II),

CH₂═CR¹—C(O)O—R⁴ (II),

where R¹ is a hydrogen atom or a methyl group, preferably a hydrogen atom, where R⁴ is a branched alkyl group having 3 to 16 carbon atoms, preferably having 3 to 12 carbon atoms, or a phenoxyalkyl radical having 8 to 16 carbon atoms, preferably having 8 to 12 carbon atoms, particularly preferably a branched alkyl group having 3 to 10 carbon atoms, preferably in a combined mass fraction in the range from 10% to 65%, more preferably in the range from 30% to 60%, very preferably in the range from 40% to 50%, based on the mass of the monomer composition.

It also follows from the observations above that the monomer composition in especially preferred cases consists by far predominantly, and preferably substantially completely, of first, second and fourth monomers. Preferred correspondingly is a PSA of the invention wherein the monomer composition, based on the mass of the monomer composition, comprises first monomers, second monomers and fourth monomers in a combined mass fraction of 80% or more, preferably 90% or more, more preferably 95% or more, very preferably 98% or more, especially preferably 99% or more.

As elucidated above, the adverse effect of the specific third monomers on the resistance of PSAs of the invention to cellulose nitrate is surprising. With a view to this effect, which can only be described phenomenologically, the inventors propose that for applications in the printing sector it might well be advantageous if the mass fraction of such monomers, possessing certain structural similarities with the third monomers, was also limited. These fifth monomers, which correspondingly encompass the third monomers, can probably best be described, in the estimation of the inventors, as aliphatic monomers which possess a bicyclic or polycyclic radical, as is the case in isobornyl acrylate as well, for example. Preferred on this assumption is a PSA of the invention wherein the monomer composition, based on the mass of the monomer composition, comprises:
v) a combined mass fraction of at most 10%, preferably at most 5%, more preferably at most 1%, of fifth monomers selected from the group consisting of (meth)acrylic esters having an aliphatic, bicyclic or polycyclic radical.

In the context of the present invention the inventors have recognized that the advantages of PSAs of the invention may be realized in particular through the use of specific branched monomers. Against this background it appears to be conducive to an optimal resistance to cellulose nitrate for the fraction of monomers having linear radicals, especially comparatively short linear radicals, to be limited. Preferred accordingly is a PSA of the invention wherein the monomer composition, based on the mass of the monomer composition, comprises:
vi) a combined mass fraction of at most 20%, preferably at most 10%, more preferably at most 5%, very preferably at most 1%, of sixth monomers selected from the group consisting of (meth)acrylic esters, preferably methacrylic esters, of the formula (II),

CH₂═CR¹—C(O)O—R⁵ (II),

where R¹ is a hydrogen atom or a methyl group, preferably a methyl group, and where R⁵ is a linear alkyl group having 3 to 30 carbon atoms.

As elucidated above, the monomer composition may in principle use a large multiplicity of possible monomers, including, for example, ethylenically unsaturated monomers which are not (meth)acrylates. Accordingly, however, in the estimation of the inventors it is particularly advantageous if (meth)acrylic esters are also used as further monomers. Preference is therefore given to a PSA of the invention wherein the monomer composition, based on the mass of the monomer composition, comprises:
vii) one or more seventh monomers selected from the group consisting of other (meth)acrylic esters, which differ from the first, second, third, fourth, fifth and sixth monomers, preferably in a combined mass fraction of up to 100% minus the combined mass fraction of the first, second, third, fourth, fifth and sixth monomers.

The PSA of the invention preferably additionally comprises at least one tackifying resin, the tackifying resin being selected preferably from the group consisting of (meth)acrylate resins, pinene resins and indene resins, rosin and rosin derivatives such as rosin esters, polyterpene resins, terpene-phenol resins, alkylphenol resins, and aliphatic, aromatic and aliphatic-aromatic hydrocarbon resins. With particular preference the mass fraction of the tackifying resins in the PSA is 30% or less, preferably 20% or less, based on the mass of the PSA.

The PSA of the invention preferably comprises additionally or alternatively at least one plasticizer, the plasticizer being selected with particular preference from the group consisting of (meth)acrylate oligomers, phthalates, hydrocarbon oils, cyclohexane-dicarboxylic esters, benzoic esters, water-soluble plasticizers, plasticizing resins, phosphates and polyphosphates, particularly preferably phthalates, cyclohexane-dicarboxylic esters and benzoic esters, very preferably benzoic esters. The PSA of the invention preferably comprises plasticizers in a mass fraction of 30% or less, preferably 20% or less, particularly preferably 15% or less. For the further optimization of the physicochemical properties of the PSA of the invention it may further comprise additional familiar additives such as fillers, examples being electrically conductive filling materials, thermally conductive filling materials or flame retardants, for example ammonium polyphosphate and its derivatives.

PSAs of the invention may be used for example directly as adhesives, and may also be provided in the form of tapes, for example, depending on method of application. With a view to very favourable handling qualities, however, particularly advantageous results are generally achieved when PSAs of the invention are used as an adhesive layer of a single-sided or double-sided pressure-sensitive adhesive tape further comprising a carrier layer. For the fastening of printing plates in particular, double-sided pressure-sensitive adhesive tapes are preferred that employ a PSA of the invention on both sides. The invention therefore also relates to a pressure-sensitive adhesive tape, more particularly a double-sided pressure-sensitive adhesive tape, comprising a carrier layer and as pressure-sensitive adhesive a pressure-sensitive adhesive of the invention.

The term “adhesive tape” is clear to the person skilled in the art of adhesive bonding technology. In the context of the present invention, the expression “tape” designates all thin sheetlike structures, i.e. structures having a predominant extent in two dimensions, more particularly films, film portions and labels, preferably tapes with extended length and limited width, and also corresponding tape portions.

The carrier layer usually designates that layer of a multi-layer adhesive tape of this kind that critically determines the mechanical and physical properties of the adhesive tape, such as the tear resistance, stretchability, insulation capacity or resilience, for example. Examples of customary materials for the carrier layer are woven fabrics, laid scrims and polymeric films, for example PET films and polyolefin films. The carrier layer, however, may also itself be pressure-sensitively adhesive. The pressure-sensitive adhesive tape of the invention may in one preferred embodiment be a double-sided pressure-sensitive adhesive tape whose carrier layer is furnished on both sides with a PSA of the invention. In pressure-sensitive adhesive tapes of the invention, the adhesive layers may be lined with what is called a release liner, in order to enable trouble-free unwinding and to protect the PSA from fouling. Such release liners customarily consist of a single-sidedly or double-sidedly siliconized polymeric film (e.g. PET or PP) or of a siliconized paper carrier.

Further disclosed, starting from the pressure-sensitive adhesive tape of the invention, is the use of a pressure-sensitive adhesive of the invention or of a pressure-sensitive adhesive tape of the invention, more particularly a double-sided pressure-sensitive adhesive tape, for the fastening of printing plates, more particularly flexible printing plates, to a printing cylinder or a printing sleeve, for the purpose of improving the detachability of the printing plates in the context of the processing of ink containing cellulose nitrate.

Preferred embodiments of the invention are described and elucidated further hereinafter with reference to experiments.

### 1. Preparation of the Poly(Meth)Acrylates:

TABLE 1
Composition of the poly(meth) acrylates - Part 1
figures in mass fractions in %

| | AA | BA | EHA | iC17 | MNA | PHA | PEA | iBA | iBOA | iSTA | LA |
|---|---|---|---|---|---|---|---|---|---|---|---|
| C1 | 8 | | | 92 | | | | | | | |
| C2 | 8 | | | 68 | | | | 24 | | | |
| C3 | 3 | | | 75 | | | 12 | | 10 | | |
| C4 | 12 | | | 64 | | | 12 | | 12 | | |
| C5 | 12 | | | 65 | | | | | 24 | | |
| C6 | 10 | | | | 90 | | | | | | |
| C7 | 8 | | | 49 | 43 | | | | | | |
| C8 | 9 | | | 45.5 | 45.5 | | | | | | |
| C9 | 8 | | | | 46 | 46 | | | | | |
| C10 | 12 | 73 | | | | | 15 | | | | |
| C11 | 12 | | | | | | | 28 | | | 60 |
| C12 | 12 | 28 | | | | | | 60 | | | |
| C13 | 12 | | 60 | | | | | 28 | | | |
| C14 | 12 | | 88 | | | | | | | | |
| C15 | 12 | | | | 60 | | | 28 | | | |
| C16 | 12 | | | | | 24 | | | | 64 | |

TABLE 2
Composition of the poly(meth) acrylates - Part 2
figures in mass fractions in %

| | AA | iC17 | MNA | PHA | PEA | iBA | iBOA | STA | LA |
|---|---|---|---|---|---|---|---|---|---|
| I1 | 10 | 90 | | | | | | | |
| I2 | 12 | 88 | | | | | | | |
| I3 | 10 | 66 | | | | 24 | | | |
| I4 | 12 | 64 | | | | 24 | | | |
| I5 | 12 | 64 | | | 24 | | | | |
| I6 | 10 | | | 90 | | | | | |
| I7 | 10 | 65 | | 25 | | | | | |
| I8 | 10 | 45 | | 45 | | | | | |
| I9 | 10 | 25 | | 65 | | | | | |
| I10 | 10 | 45 | 45 | | | | | | |
| I11 | 10 | 25 | 65 | | | | | | |
| I12 | 10 | 42.5 | 42.5 | | | | | | 5 |
| I13 | 10 | 42.5 | 42.5 | | | | | 5 | |
| I14 | 10 | 42.5 | 42.5 | | | | 5 | | |
| I15 | 10 | | 45 | 45 | | | | | |

TABLE 3
Monomers used

| Abbreviation | Monomer |
|---|---|
| AA | Acrylic acid |
| BA | n-Butyl acrylate |
| EHA | Ethylhexyl acrylate |
| iC17 | Isoheptadecyl acrylate |
| MNA | Methylnonyl acrylate |
| PHA | Propylheptyl acrylate |
| PEA | Phenoxyethyl acrylate |
| iBA | Isobutyl acrylate |
| iBOA | Isobornyl acrylate |
| iSTA | Isostearyl acrylate |
| STA | n-Stearyl acrylate |
| LA | Lauryl acrylate |

A reactor conventional for radical polymerizations was charged, for preparing the poly(meth)acrylates C1 to C16 and 11 to 115 listed in Tables 1 and 2, in each case with 100 kg of the specified monomers in the specified mass fractions, and 72.4 kg of an acetone/benzine mixture (50:50).

After nitrogen gas had been passed through the reactor for 45 minutes, with stirring, the reactor was heated up to 58° C. and 50 g of 2,2′-azobis(2-methylbutyronitrile) were added. Subsequently the external heating bath was heated to 70° C. and the reaction was carried out constantly at this external temperature. After 1 h a further 50 g of 2,2′-azobis(2-methyl-butyronitrile) were added. After each of 2, 3 and 4 h, dilution took place with 15 kg of acetone/benzine mixture (50:50).

After 5.5 h and again after 7 h, the system was re-initiated with in each case 150 g of bis(4-tert-butylcyclohexyl) peroxydicarbonate. After a reaction time of 22 h, the polymerization was discontinued and the system was cooled to room temperature. The conversions achieved in each case were virtually quantitative.

### 2. Production of Pressure-Sensitive Adhesive Tapes:

The poly(meth)acrylates were blended in each case with 0.05 wt %, based on the poly(meth)acrylate, of the crosslinker N,N,N′,N′-tetrakis(2,3-epoxypropyl)-m-xylene-α,α′-diamine (trade name Erisys GA 240) to crosslink the poly(meth)acrylate. The mixture was subsequently diluted with acetone to a solids content of 30 wt % and then coated from solution onto a double-sidedly siliconized liner material. After drying for 15 minutes at 120° C., the adhesive coat weight is 35 g/m².

For the production of double-sided pressure-sensitive adhesive tapes, the coated liner material is laminated on the adhesive side to a PET film with a thickness of 23 μm which has been double-sidedly etched using trichloroacetic acid. Subsequently, via a transfer carrier, a standard commercial acrylate adhesive with a coat weight of 20 g/m², or an adhesive with similar properties, is laminated onto the uncoated side of the etched PET film of the assembly, and a PE-EVA foam with a thickness of 500 μm and a density of 250 kg/m³ is laminated on.

Laminated onto this foam carrier, via a transfer carrier, is a standard commercial acrylate PSA with a coat weight of 60 g/m², lamination taking place onto the uncoated side of the previous assembly (exposed pressure-sensitive acrylate layer).

### 3. Evaluation of the Detachability of Printing Plates:

The tests for appraising the detachability of printing plates bonded with pressure-sensitive adhesive tapes produced as in section 2, and for investigating the influence of cellulose nitrate on the detachability, are carried out under test conditions with a temperature of 23° C.+/−1° C. and a relative humidity of 50%+/−5%.

The flexible printing plate used in the tests is a DuPont Cyrel HOS printing plate exposed over its full area, with dimensions of length 420 mm×width 330 mm×thickness 1.14 mm. To obtain the flexible printing plates for the reference samples, the PET side of the plate is cleaned with isopropanol and left to dry in the air for 5 minutes to allow the solvent to evaporate completely.

In order to obtain plates contaminated with cellulose nitrate, the PET side of the printing plates, cleaned as described above, is additionally coated, using a section of cotton wool with dimensions of length 30 mm×width 30 mm×thickness 4 mm bearing 5 mL of a cellulose nitrate solution (0.1% cellulose nitrate in 99% ethanol). This coating takes place in stripes, initially horizontally, with the printing plate being wetted over its full area with the solution. The plate is subsequently coated using the same cotton wool section a second time, this time in vertical direction. The plate is then left to stand in the air for 1 minute to allow the solvent to evaporate.

Specimens measuring 480 mm×340 mm are cut from each of the double-sided pressure-sensitive adhesive tapes under investigation. These specimens are then adhered by the exposed pressure-sensitive acrylate layer to a steel cylinder having a diameter of 110 mm such that the longer edges of the specimens are oriented in the longitudinal direction of the cylinder. The liner material is subsequently removed, so that the layer of the PSA under investigation is exposed.

The printing plates for the reference samples and, respectively, the printing plates contaminated with cellulose nitrate are bonded to the respective PSA on the pressure-sensitive adhesive tapes thus bonded, in such a way that 20 mm of the underlying pressure-sensitive adhesive tape projects at each vertical edge of the printing plate (centred application on the pressure-sensitive adhesive assembly specimen).

Starting from the top edge of the printing plate, the respective printing plate is then rolled down using a rubber roller (width 100 mm, diameter 30 mm, Shore hardness A 45). This rolling movement is made in the longitudinal direction of the printing cylinder and is performed continuously from one long edge of the plate to the opposite long edge of the plate and back. The rolling velocity in transverse direction is 10 m/min. The printing cylinder rotates simultaneously with a surface velocity of 0.6 m/min, and so the rubber roller describes a zigzag movement relative to the printing plate, in the direction of the second transverse edge of the plate. The mounting of the plate on the pressure-sensitive adhesive tape is made with the appropriate pressing force which is needed to affix the plate over the full area and without edge lifting. The steel cylinder, with the respective pressure-sensitive adhesive tape and the printing plate adhered in each case, is stored standing on one of its end faces for 72 hours at 40° C.

The force subjectively needed to demount the respective printing plates is assessed by an experienced operative. Demounting is carried out standing, with the feet apart at shoulder width. The printing plate is grasped by both hands at an edge extending to the longitudinal direction of the steel cylinder, and is pulled off at about 300 mm/min in the transverse direction to the steel cylinder (radially).

The application of force and the detachment behaviour are evaluated using a qualitative evaluation scale from 1 to 5 that is utilized in the sector (1: very easy, 2: easy, 3: acceptable, 4: difficult, 5: very difficult).

A pressure-sensitive adhesive is deemed to be suitable when the detachment behaviour of the reference sample, i.e. with a cleaned printing plate with no effect of cellulose nitrate, is rated at 1 or 2 and, moreover, the detachment behaviour of the test sample, i.e. with the influence of cellulose nitrate, is rated at 1, 2 or 3.

The results obtained are summarized in Table 4.

TABLE 4
Detachment behaviour

| | Reference | Test | | Reference | Test |
|---|---|---|---|---|---|
| PSA | sample | sample | PSA | sample | sample |
| C1 | 3 | 5 | I1 | 2 | 2 |
| C2 | 2 | 4 | I2 | 1 | 1 |
| C3 | 2 | 5 | I3 | 2 | 3 |
| C4 | 2 | 5 | I4 | 1 | 2 |
| C5 | 2 | 5 | I5 | 1 | 2 |
| C6 | 2 | 5 | I6 | 2 | 3 |
| C7 | 3 | 4 | I7 | 1 | 3 |
| C8 | 3 | 4 | I8 | 2 | 3 |
| C9 | 3 | 4 | I9 | 1 | 2 |
| C10 | 1 | 5 | I10 | 1 | 2 |
| C11 | 2 | 5 | I11 | 2 | 3 |
| C12 | 3 | 5 | I12 | 1 | 2 |
| C13 | 2 | 5 | I13 | 1 | 2 |
| C14 | 2 | 5 | I14 | 2 | 3 |
| C15 | 2 | 5 | I15 | 2 | 2 |

| | | |
|---|---|---|
| C16 | 3 | 5 |

The results compiled in Table 4 confirm that all of the PSAs of the invention are suitable for the use and still ensure at least acceptable detachability or in many cases even an easy or even very easy detachability even after treatment with cellulose nitrate.

The comparison of PSAs of the invention with comparative samples which comprise less than 10% of first monomers shows clearly that a minimum amount of these monomers is needed, with the general adhesive performance of the PSAs becoming noticeably poorer from about 15% and generally inadequate from 20%.

For the purpose of achieving the object, the specific second monomers are important, and the experiments are able to demonstrate the positive effect for different monomers in different poly(meth)acrylates and very different mass fractions, with the advantageous effect also being achievable with combinations of the second monomers.

The great relevance of the specific selection of the second monomers is manifested particularly in comparison with those poly(meth)acrylates which rather than propylheptyl acrylate employ the less branched methylnonyl acrylate, since here, despite the same empirical formula, the adhesive properties observed are very different.

The experiments further document the surprising adverse effect of isobornyl acrylate, which it exerts at relatively high mass fractions.

It is clearly evident that particularly highly performing PSAs with high mass fractions of second monomers are obtained, with second monomers of the first “or” alternative, for example isoheptadecyl acrylate, leading in particular to excellent results.

1. Pressure-sensitive adhesive for the bonding of printing plates, comprising one or more poly(meth)acrylates in a combined mass fraction of 50% or more, based on the mass of the pressure-sensitive adhesive,
wherein the one or more poly(meth)acrylates are preparable by polymerization of a monomer composition comprising, based on the mass of the monomer composition:
i) one or more first monomers selected from the group consisting of acrylic acid, methacrylic acid, dimethylacrylamide, hydroxybutyl acrylate, hydroxypropyl acrylate and hydroxyethyl acrylate in a combined mass fraction in the range from 10% to 20%, and
ii) one or more second monomers selected from the group consisting of (meth)acrylic esters of the formula (I),
CH₂═CR¹—C(O)O—CHR²R³ (I),
where R¹ is a hydrogen atom or a methyl group, where either i) R² is a hydrogen atom and R³ is a branched alkyl group having 16 to 20 carbon atoms, or ii) R² is a linear or branched alkyl group having 3 to 10 carbon atoms and R³ a linear or branched alkyl group having 6 to 10 carbon atoms, in a combined mass fraction in the range from 20% to 90%.

2. Pressure-sensitive adhesive according to claim 1, wherein the combined mass fraction of the one or of the two or more poly(meth)acrylates is 60% or more, based on the mass of the pressure-sensitive adhesive.

3. Pressure-sensitive adhesive according to claim 2, wherein the combined mass fraction of the one or of the two or more poly(meth)acrylates is 90% or more, based on the mass of the pressure-sensitive adhesive

4. Pressure-sensitive adhesive according to claim 1, wherein the monomer composition, based on the mass of the monomer composition:
i1) comprises the one or more first monomers in a combined mass fraction in the range from 10% to 15%, and/or
ii1) comprises the one or more second monomers in a combined mass fraction in the range from 40% to 90%, and/or
iii1) comprises a combined mass fraction of at most 8% of third monomers.

5. Pressure-sensitive adhesive according to claim 4, wherein the monomer composition, based on the mass of the monomer composition:
i1) comprises the one or more first monomers in a combined mass fraction in the range from 10% to 13%, and/or
ii1) comprises the one or more second monomers in a combined mass fraction in the range from 60% to 90%, and/or
iii1) comprises a combined mass fraction of at most 1% of the third monomers.

6. Pressure-sensitive adhesive according to claim 1, where in the monomer composition:
i2) the one or more first monomers are selected from the group consisting of acrylic acid, methacrylic acid and dimethylacrylamide, and/or
ii2) the one or more second monomers are selected from the group consisting of (meth)acrylic esters of the formula (I),
CH₂═CR¹—C(O)O—CHR²R³ (I),
where R¹ is a hydrogen atom or a methyl group, where either i) R² is a hydrogen atom and R³ is a branched alkyl group having 16 to 19 carbon atoms, or ii) R² is a linear or branched alkyl group having 3 to 8 carbon atoms, and R³ a linear or branched alkyl group having 4 to 9 carbon atoms.

7. Pressure-sensitive adhesive according to claim 6, where in the monomer composition:
ii3) the one or more second monomers are selected from the group consisting of isoheptadecyl (meth)acrylate and propylheptyl (meth)acrylate.

8. Pressure-sensitive adhesive according to claim 7, where in the monomer composition:
ii3) the one or more second monomers are selected from the group consisting of isoheptadecyl acrylate and propylheptyl acrylate.

9. Pressure-sensitive adhesive according to claim 1, wherein the monomer composition comprises one or more second monomers in which R² is a hydrogen atom and R³ is a branched alkyl group having 16 to 20 carbon atoms, and comprises one or more second monomers in which R² is a linear or branched alkyl group having 3 to 10 carbon atoms and R³ a linear or branched alkyl group having 6 to 10 carbon atoms.

10. Pressure-sensitive adhesive according to claim 9, wherein the monomer composition comprises one or more second monomers in which R² is a hydrogen atom and R³ is a branched alkyl group having 16 to 20 carbon atoms in a combined mass fraction in the range from 20% to 70%, and comprises one or more second monomers in which R² is a linear or branched alkyl group having 3 to 10 carbon atoms and R³ a linear or branched alkyl group having 6 to 10 carbon atoms, in a combined mass fraction in the range from 20% to 70.

11. Pressure-sensitive adhesive according to claim 10, wherein the monomer composition comprises one or more second monomers in which R² is a hydrogen atom and R³ is a branched alkyl group having 16 to 20 carbon atoms, in a combined mass fraction in the range from 25% to 65%, and comprises one or more second monomers in which R² is a linear or branched alkyl group having 3 to 10 carbon atoms and R³ a linear or branched alkyl group having 6 to 10 carbon atoms, in a combined mass fraction in the range from 25% to 65%.

12. Pressure-sensitive adhesive according to claim 1, wherein the monomer composition comprises:
iv) one or more fourth monomers selected from the group consisting of (meth)acrylic esters of the formula (II),
CH₂═CR¹—C(O)O—R⁴ (II),
where R¹ is a hydrogen atom or a methyl group, where R⁴ is a branched alkyl group having 3 to 16 carbon atoms, or a phenoxyalkyl radical having 8 to 16 carbon atoms.

13. Pressure-sensitive adhesive according to claim 12, wherein the monomer composition comprises:
iv) one or more fourth monomers selected from the group consisting of (meth)acrylic esters of the formula (II),
CH₂═CR¹—C(O)O—R⁴ (II),
where R¹ is a hydrogen atom or a methyl group, where R⁴ is a branched alkyl group having 3 to 16 carbon atoms, or a phenoxyalkyl radical having 8 to 12 carbon atoms, in the range from 40% to 50%, based on the mass of the monomer composition.

14. Pressure-sensitive adhesive according to claim 12, wherein the monomer composition, based on the mass of the monomer composition, comprises first monomers, second monomers and fourth monomers in a combined mass fraction of 80% or more.

15. Pressure-sensitive adhesive according to claim 14, wherein the monomer composition, based on the mass of the monomer composition, comprises first monomers, second monomers and fourth monomers in a combined mass fraction of 95% or more.

16. Pressure-sensitive adhesive according to claim 15, wherein the monomer composition, based on the mass of the monomer composition, comprises first monomers, second monomers and fourth monomers in a combined mass fraction of 98% or more.

17. Pressure-sensitive adhesive tape comprising a carrier layer and as pressure-sensitive adhesive a pressure-sensitive adhesive according to claim 1.

18. A method of fastening a printing plate on a printing cylinder or a printing sleeve, said method comprising fastening the printing plate to the printing cylinder or printing sleeve via a pressure-sensitive adhesive according to claim 1 or via a pressure-sensitive adhesive tape comprising said pressure-sensitive adhesive.

19. The method according to claim 18, which is conducted in the context of printing with ink containing cellulose nitrate, and the method results in improved detachability of the printing plate from the printing cylinder or printing sleeve.
